(19) United States
(12) Patent Application Publication
(10) Pub. No.: US 2026/0288475 A1
(43) Pub. Date: Sep. 24, 2026

(54) GENERATING BOOTABLE DISK IMAGE USING CONTAINER-BASED PARTITION TABLE

(71) Applicant: Red Hat, Inc., Raleigh, NC (US)

(72) Inventors: Maxime Ripard, Puteaux (FR); Eric Curtin, Dublin (IE)

(21) Appl. No.: 19/088,576

(22) Filed: Mar. 24, 2025

(51) Int. Cl. G06F 9/4401

(52) U.S. Cl. CPC G06F 9/4401

(57) ABSTRACT

A method, a system, and a non-transitory computer-readable storage medium are provided. The method includes obtaining, on a first hardware platform, a container image corresponding to a containerized first operating system (OS). The method includes extracting, from the container image, metadata of the containerized first OS, the metadata comprising a specification of a second OS configured to be executed on a second hardware platform different from the first hardware platform. The method includes generating, by a processing device, a disk image of the first hardware platform based on the specification. The method includes storing the disk image in a storage device according to the specification.

### TECHNICAL FIELD

Aspects of the present disclosure relate to computer systems, and, more specifically, to container-based cross-platform disk image generation.

### BACKGROUND

Computer systems execute on hardware platforms, which typically include one or more processors and memory spaces. Different hardware platforms often support different computer systems, which in turn often have different specifications for configuring and managing the memory spaces.

### BRIEF DESCRIPTION OF THE DRAWINGS

FIG. 1A is a block diagram that illustrates an example computer system with multiple hardware platforms, in accordance with some implementations.

FIG. 1B is a diagram that illustrates example data processing operations within a computing device, in accordance with some implementations.

FIG. 2 is a block diagram that illustrates example mappings between a container image and a disk image, in accordance with some implementations.

FIG. 3 is a flowchart of a method of container-based cross-platform disk image generation, in accordance with some implementations.

FIG. 4 is a block diagram of an example computing device that may perform one or more of the operations described herein, in accordance with some implementations.

### DETAILED DESCRIPTION

Many different types of hardware platforms exist in today's computer systems. For example, the x86 platform and the ARM platform are two common hardware platforms widely used in today's computing devices, such as personal computers, mobile devices, servers, and embedded systems. Different hardware platforms often have different architectures and support different operating systems (OSs) configured to manage the computing and storage resources of the hardware platforms.

An OS executing on a computing device may be containerized. For example, a computer may create an image of the OS executing on the computer, along with the applications running on the OS. The computer may pack the image in a container and provide the container to another computer. The other computer may then deploy the container image by executing the OS and the applications running thereon.

While containerization is a convenient approach for reusing computing resources and distributing applications across computing devices, it is challenging under existing technologies to deploy container images across different hardware platforms. This is because different hardware platforms may have different settings for booting an OS and partitioning a memory space (e.g., into one or more disks). For example, ARM devices sometimes lack consistent bootloader (e.g., a module that executes instructions to load the OS) standards. Accordingly, to create a bootable system for an ARM-based hardware platform, one often has to manually configure the bootloader, the partition table (e.g., a table that indicates the partitioning of a memory space), and firmware based on the specification that may be unique to the ARM-based hardware platform. Despite the existence of solutions to streamline the creation of embedded systems, these solutions usually lack the flexibility to support custom, user-managed OS installations. In particular, existing ARM distribution and customization tools either are limited to specific platforms or require specialized scripting knowledge, hence restricting user accessibility and reducing compatibility across devices.

This disclosure provides techniques that address the challenges described above. As described in detail below, one or more implementations of this disclosure provide a tool that leverages containerization to standardize and automate the process of generating a bootable disk image deployable on different types of hardware platforms. According to some implementations, a computing device obtains, on a first hardware platform, a container image corresponding to a containerized first (OS). The computing device extracts, from the container image, metadata of the containerized first OS. The metadata includes a specification of a second OS configured to be executed on a second hardware platform different from the first hardware platform. A processing device of the computing device generates a disk image based on the specification. The computing device stores the disk image in a storage device according to the specification. With one or more features described below in detail, implementations of this disclosure advantageously improve the efficiency of resource utilization and the flexibility of application distribution across different hardware platforms.

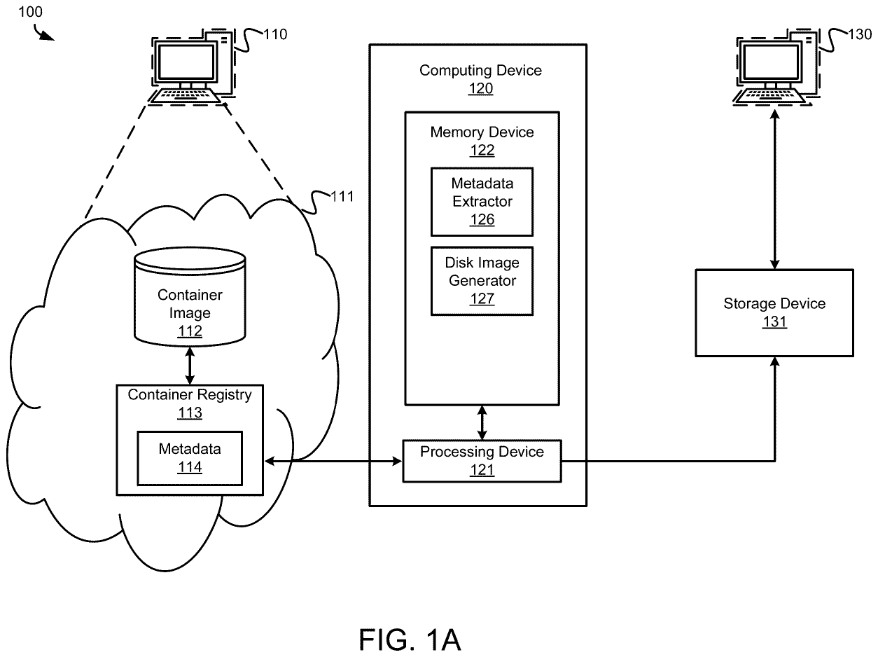

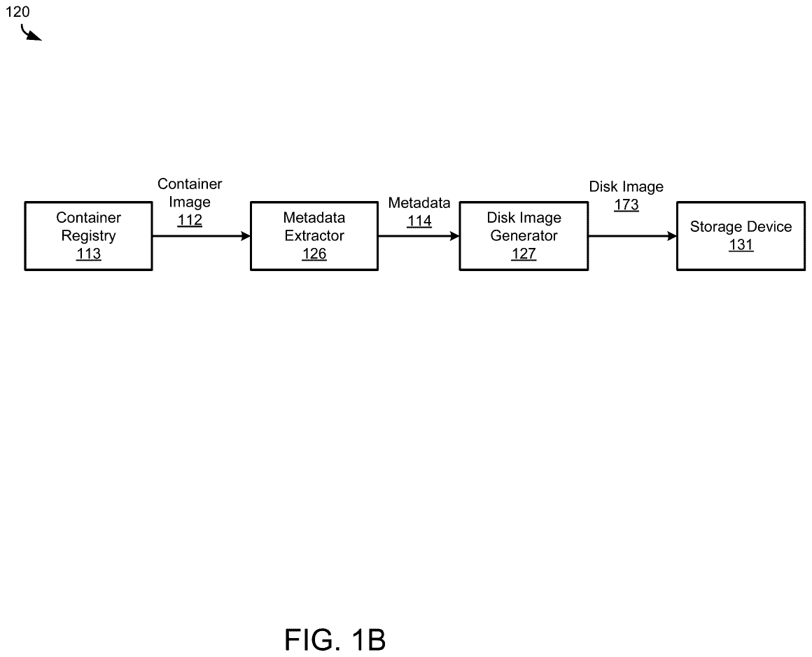

FIG. 1A is a block diagram that illustrates an example computer system 100 with multiple hardware platforms, in accordance with some implementations. As illustrated, computer system 100 includes first hardware platform 110 and second hardware platform 130. First hardware platform 110 may be configured to execute a containerized first operating system (OS) 111, such as a RED HAT OS. First hardware platform 110 may create container image 112 of OS 111 and publish container image 112 in container registry 113. For example, when a user wishes to have a container image for an ARM64 platform, first hardware platform 110 may create container image 112 based on the ARM64 architecture. In some implementations, first hardware platform 110 executes a tool, such as BUILDAH, to include metadata 114 within container image 112, where metadata 114 may further include a label describing container image 112 and other configurations or specifications that are specifically related to the ARM64 platform. Container registry 113 may further include information about the file system, such as files used when booting OS 111.

Computer system 100 also includes second hardware platform 130, which may be an embedded platform having an embedded OS configured to execute thereon. First hardware platform 110 may, as described later, provide information for generating a disk image that is bootable on second hardware platform 130. Accordingly, first hardware platform 110 operates as a source hardware platform, whereas second hardware platform 130 operates as a target hardware platform.

Second hardware platform 130 also has an OS configured to be executed thereon (“second OS”), which may or may not be containerized. Second hardware platform 130 is coupled to storage device 131, which may store system files and user data. In some implementations, storage device 131 is integrated within second hardware platform 130.

The OS on second hardware platform 130 may have different specifications with respect to booting and file system partitioning from those of OS 111. Due to the differences, it is often challenging to directly deploy and boot container image 112 on second hardware platform 130. To address this challenge, computer system 100 has computing device 120 communicatively coupled to both first hardware platform 110 and second hardware platform 130. In some implementations, computing device 120 is structurally separate from first hardware platform 110 and second hardware platform 130. For example, computing device 120 may be a standalone machine with hardware that is not shared with first hardware platform 110 or second hardware platform 130. Alternatively or additionally, computing device 120 structurally overlaps with at least one of first hardware platform 110 and second hardware platform 130. For example, computing device 120 may be implemented as a software module, such as bootc, that is installed on second hardware platform 130 and utilizes the hardware of second hardware platform 130 to execute.

As illustrated, computing device 120 includes processing device 121 and memory device 122 coupled to each other. Memory device 122 stores computer-executable instructions, e.g., source code, that correspond to one or more functional modules. Example functional modules include metadata extractor 126 and disk image generator 127. By executing instructions corresponding to the functional modules, processing device 121 can generate a disk image based on container image 112 that is bootable on second hardware platform 130.

FIG. 1B is a diagram that illustrates example data processing operations within a computing device 120, in accordance with some implementations. The illustrated operations may be performed by processing device 121 by executing instructions stored in memory device 122, as illustrated in FIG. 1A.

Referring to FIGS. 1A and 1B, metadata extractor 126 of computing device 120 accesses container registry 113 of first OS 111 to obtain container image 112. Metadata extractor 126 then extracts metadata 114 from container image 112. For example, metadata extractor 126 may identify a container label of container image 112 and extract, from the container label, information describing disk space partition layout on first hardware platform 110. Metadata extractor 126 may also extract, from the container labels, location information of a bootloader within the disk space of first hardware platform 110. Metadata extractor 126 provides metadata 114 to disk image generator 127.

Disk image generator 127 receives metadata 114 from metadata extractor 126 and, based on the extracted information about the partition layout and bootloader location, generates disk image 173 that may be loaded and booted on second hardware platform 130. In some implementations, disk image generator 127 uses the metadata to construct a data structure, such as a partition table, that corresponds to the first hardware platform 110. Disk image generator 127 then generates disk image 173 including the partition table and outputs disk image 173. The generation of disk image 173 may take place within computing device 120, independent to the operations of OS 111 on first hardware platform 110. Based on the specification in metadata 114, disk image generator 127 may generate disk image 173 that is loadable on second hardware platform 130, e.g., in compliance with the system requirements of the second OS.

The specification may include settings, configurations, instructions, partition requirements, or mappings that are compliant with industry partitioning standards, such as globally unique identifier (GUID) partition table (GPT) or master boot record (MBR) partition table. The specification may also include settings, configurations, instructions, partition requirements, or mappings that are specified by the second OS running on second hardware platform 130. For example, when second hardware platform 130 is an ARM (including ARM64) platform running an embedded OS, the specification may include settings, configurations, instructions, partition requirements, or mappings tailored for such an embedded OS. The specification may provide default values for some configurations, such as the total number of partitions, and may allow the default values to be overridden by customized values from, e.g., a user application that interacts with computing device 120.

Due to the possible differences between first hardware platform 110 and second hardware platform 130, disk image generator 127 may validate disk image 173 based on the specification, e.g., to identify items within disk image 173 that are incompliant with or unsupported by second hardware platform 130 or formatted differently than normally used by second hardware platform 130. Based on the validation, disk image generator 127 may then make adjustments to the identified items according to, e.g., industry standards within the specification. After the validation and adjustment operations, disk image generator 127 outputs disk image 173 with partitioning information and bootloader information that may be loaded on second hardware platform 130 to boot the corresponding OS executing thereon. As such, with limited human involvement, container image 112 is distributed from first hardware platform 110 to second hardware platform 130 in a streamlined and automatic manner, improving cross-platform portability and extensibility while saving time and effort.

According to the above operations, software packages running on first hardware platform 110 may be migrated to second hardware platform 130. For example, second hardware platform 130 may boot the second OS based on disk image 173. Based on disk image 173, second hardware platform 130 may partition its memory space (e.g., storage device 131) into one or more partitions associated with (e.g., corresponding to) one or more partitions of first hardware platform 110. For instance, if container image 112 indicates a first partition of the memory space of first hardware platform 110, then disk image 173 may indicate a second partition associated with the first partition. Based on the indication of disk image 173, second hardware platform 130 may allocate the second partition on a memory space of second hardware platform 130. With the loading of disk image 173, software packages residing on the first partition and managed by OS 111 may be migrated to the second partition and loaded by the second OS.

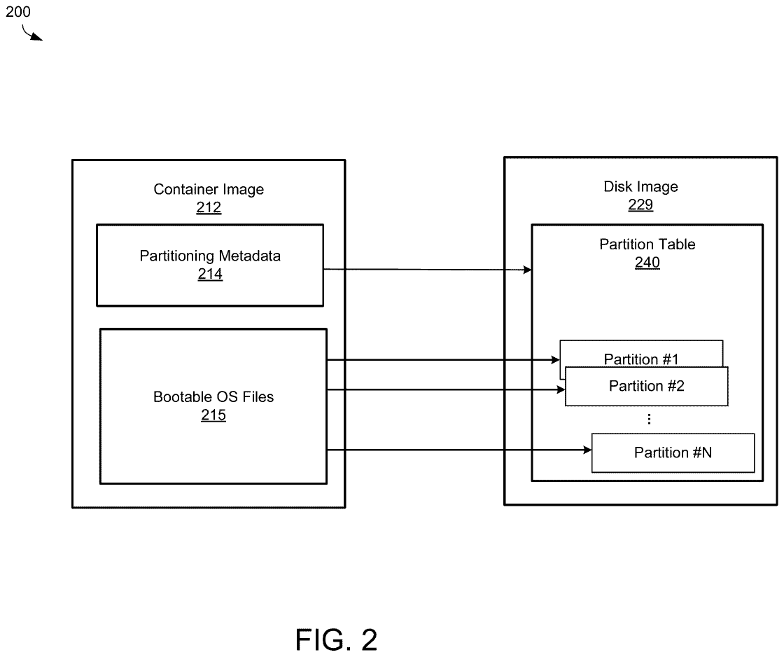

FIG. 2 is a block diagram that illustrates example mappings 200 between container image 212 and disk image 229, in accordance with some implementations. Mappings 200 may be used by processing device 121 of FIG. 1A to generate disk image 229, which may be similar to disk image 173 of FIG. 1B.

As illustrated, container image 212, which may be similar to container image 112 of FIGS. 1A and 1B, stores metadata 214 that describes, e.g., disk space partition layout information and bootloader location information corresponding to a containerized OS running on a source hardware platform. Based on metadata 214, the containerized OS can access bootable OS files 215 during booting and/or shutting.

In some implementations, processing device 121 generates partition table 240 that is mapped to metadata 214. For example, based on the disk address space and associated configurations and attributes specified in metadata 214, processing device 121 may create a data structure for disk image 229 and designate an element of the data structure for the partition table 240 having the same configurations and attributes. Also based on metadata 214, processing device 121 obtains detailed information of each disk space partition in the source hardware platform. Using the detailed information, processing device 121 creates partitions #1 to #N (N is an integer) within partition table 240, with partitions #1 to #N respectively mapped to the disk space partitions in the source hardware platform. As such, disk image 229 is generated. After validation and adjustments according to a specification of a target hardware platform, disk image 229 may be deployable and bootable on the target hardware platform.

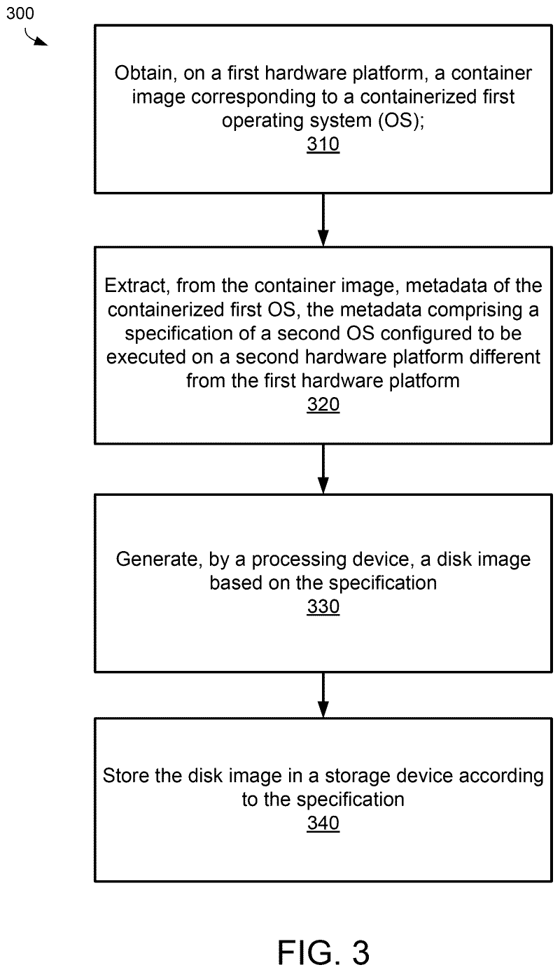

FIG. 3 is a flowchart of a method 300 of container-based cross-platform disk image generation, in accordance with some implementations. Method 300 may be performed by a computing device, such as computing device 120 of FIGS. 1A and 1B.

At 310, method 300 involves obtaining, on a first hardware platform, a container image corresponding to a containerized first operating system (OS). In some implementations, obtaining the container image includes accessing a container registry on the first hardware platform.

At 320, method 300 involves extracting, from the container image, metadata of the containerized first OS. In some implementations, the metadata includes a specification of a second OS configured to be executed on a second hardware platform different from the first hardware platform.

At 330, method 300 involves generating, by a processing device, a disk image of the first hardware platform based on the specification. In some implementations, generating the disk image includes validating the partition table of the first hardware platform based on the specification and adjusting a configuration of the partition table of the first hardware platform based on the validation.

At 340, method 300 involves storing the disk image in a storage device according to the specification. The second hardware platform thus may, by itself or based on the control of the computing device, boot the second OS using the disk image.

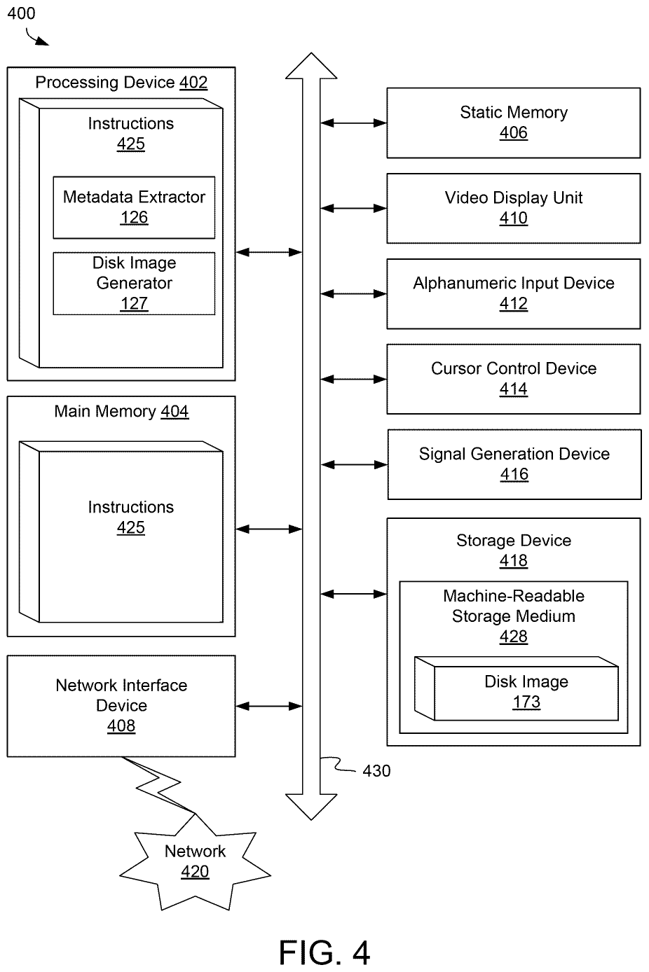

FIG. 4 is a block diagram of an example computing device 400 that may perform one or more of the operations described herein, in accordance with some implementations. Computing device 400 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 400 is similar to computing device 120. For example, computing device 400 may include a processing device (e.g., a general purpose processor, a PLD, etc.) 402, a main memory 404 (e.g., synchronous dynamic random access memory (DRAM), read-only memory (ROM)), a static memory 406 (e.g., flash memory and a data storage device 418), which may communicate with each other via a bus 430.

Processing device 402 may be provided by one or more general-purpose processing devices such as a microprocessor, central processing unit, or the like. In an illustrative example, processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 402 may also comprise one or more special-purpose processing devices such as an application specific integrated circuit (ASIC), a field programmable gate array (FPGA), a digital signal processor (DSP), network processor, or the like. The processing device 402 may be configured to execute the operations described herein, in accordance with one or more aspects of the present disclosure, for performing the operations and steps discussed herein.

Computing device 400 may further include a network interface device 408 which may communicate with a network 420. The computing device 400 also may include a video display unit 410 (e.g., a liquid crystal display (LCD) or a cathode ray tube (CRT)), an alphanumeric input device 412 (e.g., a keyboard), a cursor control device 414 (e.g., a mouse) and an acoustic signal generation device 416 (e.g., a speaker). In one implementation, video display unit 410, alphanumeric input device 412, and cursor control device 414 may be combined into a single component or device (e.g., an LCD touch screen).

Data storage device 418 may include a computer-readable storage medium 428 on which may be stored one or more sets of instructions 425 that may include instructions for, e.g., the metadata extractor 126 and the disk image generator 127, in accordance with one or more aspects of the present disclosure. Instructions 425 may also reside, completely or at least partially, within main memory 404 and/or within processing device 402 during execution thereof by computing device 400, main memory 404 and processing device 402 also constituting computer-readable media. In some implementations, the instructions 125, when residing in the computer-readable storage medium 428, include a disk image 173 generated by the disk image generator 127. The instructions 425 may further be transmitted or received over a network 420 via network interface device 408.

While computer-readable storage medium 428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “configuring,” “identifying,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular implementations only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the implementations and its practical applications, to thereby enable others skilled in the art to best utilize the implementations and various modifications as may be suited to the particular use contemplated. Accordingly, the present implementations are to be considered as illustrative and not restrictive, and the invention is not to be limited to the details given herein, but may be modified within the scope and equivalents of the appended claims.

What is claimed is:

1. A method comprising:
obtaining, on a first hardware platform, a container image corresponding to a containerized first operating system (OS);
extracting, from the container image, metadata of the containerized first OS, the metadata comprising a specification of a second OS configured to be executed on a second hardware platform different from the first hardware platform;
generating, by a processing device, a disk image based on the specification; and
storing the disk image in a storage device according to the specification.

2. The method of claim 1, wherein obtaining the container image comprising accessing a container registry on the first hardware platform.

3. The method of claim 1, wherein extracting the metadata comprises:
accessing a label of the container image; and
determining, based on the label, a partition layout of the first hardware platform and a bootloader location of the first hardware platform.

4. The method of claim 1, wherein generating the disk image comprises:
generating a data structure comprising a partition table of the first hardware platform.

5. The method of claim 4, wherein generating the disk image further comprises:
validating the partition table of the first hardware platform based on the specification; and
adjusting a configuration of the partition table of the first hardware platform based on the validation.

6. The method of claim 1, wherein the containerized first OS is configured to manage a software package on a first partition of a first memory space of the first hardware platform, the method further comprising:
booting the second OS on the second hardware platform using the disk image;
allocating, based on the disk image, a second partition of a second memory space of the second hardware platform, the second partition being associated with the first partition; and
loading the software package from the second partition.

7. The method of claim 1, wherein the second hardware platform is an embedded device.

8. A system comprising:
a memory; and
a processing device, operatively coupled to the memory, to:
obtain, on a first hardware platform, a container image corresponding to a containerized first operating system (OS);
extract, from the container image, metadata of the containerized first OS, the metadata comprising a specification of a second OS configured to be executed on a second hardware platform different from the first hardware platform;
generate, by the processing device, a disk image based on the specification; and
store the disk image in a storage device according to the specification.

9. The system of claim 8, wherein, to obtain the container image, the processing device is to access a container registry on the first hardware platform.

10. The system of claim 8, wherein, to extract the metadata, the processing device is to:
access a label of the container image; and
determine, based on the label, a partition layout of the first hardware platform and a bootloader location of the first hardware platform.

11. The system of claim 8, wherein, to generate the disk image, the processing device is to generate a data structure comprising a partition table of the first hardware platform.

12. The system of claim 11, wherein, to generate the disk image, the processing device is further to:
validate the partition table of the first hardware platform based on the specification; and
adjust a configuration of the partition table of the first hardware platform based on the validation.

13. The system of claim 8, wherein the containerized first OS is configured to manage a software package on a first partition of a first memory space of the first hardware platform, and wherein the processing device is further to:
boot the second OS on the second hardware platform using the disk image;
allocate, based on the disk image, a second partition of a second memory space of the second hardware platform, the second partition being associated with the first partition; and
load the software package on the second partition.

14. The system of claim 8, wherein the second hardware platform is an embedded device.

15. A non-transitory computer-readable storage medium including instructions that, when executed by a processing device, cause the processing device to:
obtain, on a first hardware platform, a container image corresponding to a containerized first operating system (OS);
extract, from the container image, metadata of the containerized first OS, the metadata comprising a specification of a second OS configured to be executed on a second hardware platform different from the first hardware platform;
generate, by the processing device, a disk image based on the specification; and
store the disk image in a storage device according to the specification.

16. The non-transitory computer-readable storage medium of claim 15, wherein, to extract the metadata, the instructions cause the processing device to access a container registry on the first hardware platform.

17. The non-transitory computer-readable storage medium of claim 15, wherein, to extract the metadata, the instructions cause the processing device to:
access a label of the container image; and
determine, based on the label, a partition layout of the first hardware platform and a bootloader location of the first hardware platform.

18. The non-transitory computer-readable storage medium of claim 15, wherein, to generate the disk image, the instructions cause the processing device to:
generate a data structure comprising a partition table of the first hardware platform.

19. The non-transitory computer-readable storage medium of claim 18, wherein, to generate the disk image, the instructions cause the processing device is to:
validate the partition table of the first hardware platform based on the specification; and
adjust a configuration of the partition table of the first hardware platform based on the validation.

20. The non-transitory computer-readable storage medium of claim 15, wherein the containerized first OS is configured to manage a software package on a first partition of a first memory space of the first hardware platform, and wherein the instructions further cause the processing device to:
boot the second OS on the second hardware platform using the disk image;
allocate, based on the disk image, a second partition of a second memory space of the second hardware platform, the second partition being associated with the first partition; and
load the software package from the second partition.
